(19) United States
(12) Patent Application Publication
(10) Pub. No.: US 2004/0265039 A1
(43) Pub. Date: Dec. 30, 2004

(54) Writing implement with integral page-turning element

(76) Inventor: Janice E. Buck, Irvine, CA (US)

Correspondence Address: KLEIN, O'NEILL & SINGH, 2 PARK PLAZA, SUITE 510, IRVINE, CA, 92614, US

(21) Appl. No.: 10/602,440

(22) Filed: Jun. 24, 2003

(51) Int. Cl. B43K 29/00

(52) U.S. Cl. 401/195

(57) ABSTRACT

A writing implement has a barrel extending between a first end through which a writing tip extends and a second end opposite the first end, and an integral, substantially non-abradable, substantially non-abrasive, elastomeric page-turning element fixed to and integral with the second end, wherein the page-turning element has an outside diameter that is not substantially greater than the outside diameter of the second end of the barrel. In a specific preferred embodiment, the page-turning element is configured as a conformal cap covering the second end of the barrel, and its exterior surface is advantageously formed with a multiplicity of soft, deformable protuberances to enhance the frictional grip of the page-turning element with a sheet of paper. A writing tip extension and retraction mechanism may optionally be included in the barrel, the mechanism having an actuation button on the exterior of the main body of the barrel between the first and second ends. Alternatively, the actuation button can be located at the tip or apex of the second end of the barrel, underneath the page turning-element.

### CROSS-REFERENCE TO RELATED APPLICATIONS

Not Applicable

### FEDERALLY SPONSORED RESEARCH OR DEVELOPMENT

Not Applicable

### BACKGROUND OF THE INVENTION

This invention relates generally to the field of writing implements, such as pens and markers. More specifically, it relates to a writing implement with a page-turning element permanently fixed to the end opposite the writing tip.

Despite the proliferation of computers in the workplace, paper documents continue to be a major aspect of the modern office. Many office workers must deal with large numbers of paper documents, often comprising a large number of pages or sheets. Such workers frequently must search a lengthy paper file or stack of documents for a particular document or page, requiring them to flip through many pages before finding the sought-after document or page. Typically, workers have used their fingers to turn or flip through the pages in their searches. This leads to several problems. For example, workers frequently sustain paper cuts. Also, in order to provide better grip between one's fingers and the sheets of paper, the fingers are often moistened, typically with saliva or with a moistening pad. The use of moistening agents can lead to stained or smudged documents (particularly those marked with a water-soluble ink), and saliva also is unsanitary. Furthermore, the use of fingers is often awkward and slow, because the user often is searching a file for information to enter manually into another document, or for a space that must be filled in with a pen (e.g., a signature line), and the pen must be laid aside during the flipping and then picked up when it needs to be used.

There have been several approaches taken in the prior art to address the above-noted problems. Perhaps the most common approach has been the “rubber finger” or “finger guard,” which comprises a rubber cap that fits over the end of a person's finger to provide enhanced friction between the finger and the paper. Such devices often have small bumps or protrusions on their exterior surface further to enhance friction. Such devices, however, do not address the difficulty of holding a writing implement while flipping through successive pages. Indeed, they may even increase the difficulty of writing due to the fact that device is installed on and covers the end of a finger. Furthermore, such finger guards need to be provided in different sizes to fit a variety of users, and they tend to cause and trap perspiration from the finger, which may impart an unpleasant odor to the device.

Another approach is to use an eraser attached to the writing implement to flip through paper sheets and pages. The eraser may be integral with the writing implement (as is the case with the typical pencil), or it may be a separate eraser that fits over the proximal end of a pencil. Erasers, however, are not well-suited for use as tools for flipping through paper files. Specifically, in erasing, they pick up ink, pencil graphite, and/or dirt that can soil or smear the pages with which they come into contact during the flipping procedure. Their inherently abrasive qualities can also contribute to smudging and smearing, and they wear down relatively quickly through normal use. Finally, the separate removable erasers are typically designed to fit on the end of a pencil, but they tend not to fit well on pens. In any case, they have a tendency to split after prolonged use. A variation on this concept is shown in U.S. Pat. No. 2,419,746—Veria, which discloses a removable eraser with a sponge rubber surface designed for use as a page-turning device. The sponge rubber surface, however, needs to be frequently moistened.

U.S. Pat. No. 5,735,544—Buckner discloses a page-turning device comprising a substantially spherical body with protuberances extending from its exterior surface, and a cylindrical bore configured for a removable friction fit over the proximal end of a writing implement. While this device overcomes many of the aforesaid problems with the rubber finger guard, it has other characteristics that may be disadvantageous. For example, the substantially spherical configuration gives the device an outside diameter that is considerably greater than that of the writing implement to which it is attached. This not only results in a costly waste of material that serves no purpose in the device, but also prevents the device from lying flat, thus creating possible problems with storage. In addition, the device must be removed to actuate the typical actuation button that operates the extension and retraction mechanism found in many pens. Furthermore, the cylindrical bore is sized to fit a “standard writing instrument,” but modern writing implements assume such a wide variety of shapes and sizes that the concept of a “standard” writing instrument (other than the typical pencil) is elusive, if not altogether meaningless. In other words, a “one-size-fits-all” page-turning device is likely to have limited practical utility or market appeal.

Thus there has been a long-sought, but as yet unmet need for a page-turning device that combines the high friction and non-abrading characteristics of a rubber finger guard with the convenience of being permanently attached to the end of a writing implement, and that does not need to be moistened. It would further be advantageous for such a page-turning device to have a diameter that does not substantially exceed that of the writing implement to which it is attached.

### SUMMARY OF THE INVENTION

Broadly, the present invention is a writing implement comprising a barrel having main body extending between a first end through which a writing tip extends and a second end opposite the first end, and an integral, substantially non-abradable elastomeric page-turning element fixed to and integral with the second end, wherein the page-turning element has a maximum outside diameter that is not substantially greater than the maximum outside diameter of the second end of the barrel. In a specific preferred embodiment, the page-turning element is configured as a conformal cap covering the second end of the barrel, and its exterior surface is advantageously formed with a multiplicity of integral soft, deformable protuberances or bumps to enhance its frictional grip with a sheet of paper. The writing implement may be a pen or any other marking device that uses a liquid marking medium, such as a felt tip marker. A writing tip extension and retraction mechanism may be contained within the barrel, the mechanism having an actuation button on the exterior of the main body of the barrel between the first and second ends. Alternatively, the actuation button can be located at the tip of the second end of the barrel, underneath the page-turning element.

### BRIEF DESCRIPTION OF THE DRAWINGS

FIG. 1 is an elevational view of a writing implement with an integral page-turning element, in accordance with a preferred embodiment of the invention;

FIG. 2 is an end view of the writing implement of FIG. 1, viewed from the writing tip of the implement, i.e., the left side of FIG. 1;

FIG. 3 is a detailed view of the second end of the barrel of the writing implement of the present invention, with the page-turning element attached; and

FIG. 4 is a detailed view of an alternative embodiment of the writing implement of the present invention, showing the second end of the barrel without the page-turning element.

### DETAILED DESCRIPTION OF THE INVENTION

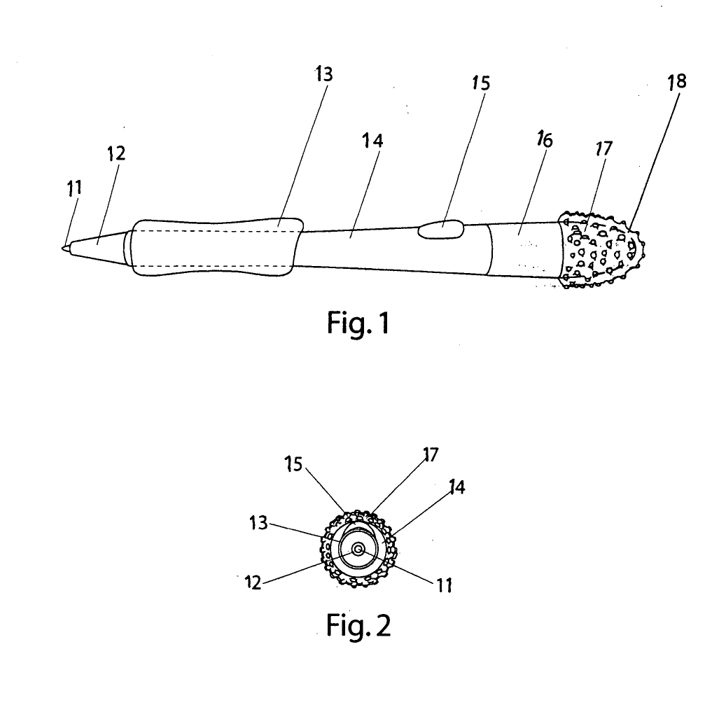

Referring first to FIGS. 1-3, a writing implement 10, in accordance with a preferred embodiment of the invention, is shown. The writing implement 10 may be a pen or any other type of marker that uses liquid ink, such as, for example, a felt tip marker. For the purposes of the present discussion, however, the writing implement 10 will be referred to as a pen. The pen 10 includes a barrel 16 having a generally cylindrical main portion 14 extending between a tapered first end 12 and a second end 17 opposite the first end 12. The first end 12 has a central aperture through which a writing tip 11 extends. The writing tip 11, in the case of a pen, may be a ballpoint, a roller ball, a nib, or a felt tip. It communicates with an ink reservoir (not shown) contained within the barrel 16. The writing tip 11 may be fixed, or, preferably, it may be retractable by a conventional extension and retraction mechanism (not shown), of any type known in the art, that is contained within the barrel 16. In the preferred embodiment, the extension and retraction mechanism is operated by means of a button 15 on the exterior of the main portion 14 of the barrel 16. The main portion 14 of the barrel 16 may advantageously be fitted with a soft elastomeric grip 13 adjacent to the first end 12.

In a preferred embodiment of the invention, the second end 17 of the barrel 16 is somewhat conical with a rounded apex or tip. Permanently fixed to the second end 17, by means such as a suitable adhesive, is an elastomeric page-turning element 18. The page-turning element 18 is preferably substantially conformal to the configuration of the second end 17, with a maximum outside diameter that is not substantially greater than the maximum outside diameter of the second end 17. For the purposes of this description, the term “not substantially greater than” should be read to mean not more than about 50% greater than, and preferably not more than about 25% greater than, the maximum outside diameter of the second end 17.

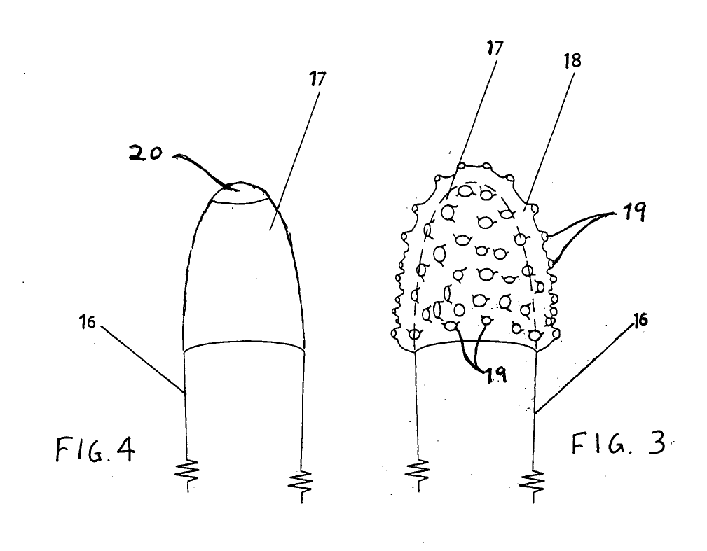

The page-turning element 18 is made of a moldable elastomeric material that is relatively soft and deformable, substantially non-abrasive, and substantially non-abradable. For the purpose of this description, the term “non-abradable” means that the material is not easily abraded or worn away by repeated frictional contact with paper. Thus the material does not cause significant abrasion of the paper, nor is it significantly abraded by the paper. The page-turning element 18 is formed with a textured, friction-enhancing exterior surface that provides a good frictional grip with a sheet of paper. Preferably, the friction-enhancing surface is provided by a multiplicity of deformable protuberances or bumps 19 that are integral with the page-turning element 18, as best shown in FIG. 3, but other types of textured surfaces, including micro-textured surfaces, may be used.

FIG. 4 shows an alternative embodiment of the writing implement, in which an actuation button 20 for the actuation of the extension and retraction mechanism extends from the tip of the second end 17 of the barrel 16. In this embodiment, the page turning-element fits over and covers the actuation button 20, and is sufficiently soft and compliant that the actuation button 20 can be actuated through the page turning element.

The present invention, as described above, offers the good page-gripping qualities of the conventional rubber finger guard, while also providing the convenience of having a page-turning element attached to proximal end of the writing implement itself. Moreover, the nature of the material from which the page-turning element is made and the textured surface provide good page-gripping characteristics without the need for moistening the device, and without problems such as page abrasion, smudging, or smearing. Furthermore, the shape and configuration of the page-turning element, with a maximum outside diameter that is not substantially greater (as defined above) than that of the implement barrel, allows the writing implement to lie substantially flat and does not interfere with the operation of an extension and retraction mechanism actuation button located in the tip of the second end of the implement's barrel. Finally, permanently fixing the page-turning element to the second end of the writing implement's barrel maximizes ease of use, attractiveness, and durability.

While a preferred embodiment and an alternative embodiment of the invention have been described above, it will be appreciated that a number of variations and modifications may suggest themselves to those skilled in the art. For example, the page-turning element may be made in a wide variety of shapes and sizes (and even colors and patterns) to fit on writing implements of diverse sizes and configurations, or to suit a wide variety of stylistic tastes. The protuberances 19 on the exterior surface of the page-turning element may be made in a geometric and/or color pattern to enhance the aesthetic qualities of the writing implement. These and other variations and modifications that may suggest themselves should be considered within the spirit and scope of the present invention, as defined in the claims that follow.

What is claimed is:

1. A writing implement, comprising:
a barrel having a first end, a second end, and a main portion extending therebetween, the barrel having a first maximum diameter;
a writing tip retractably extending from the first end; and
a page-turning element permanently fixed to the second end and having a second maximum diameter that is not substantially greater than the first maximum diameter.

2. The writing implement of claim 1, wherein the second maximum diameter is not more than about 50% greater than the first maximum diameter.

3. The writing implement of claim 2, wherein the second maximum diameter is not more than about 25% greater than the first maximum diameter.

4. The writing implement of claim 1, wherein the page-turning element is made of a soft, deformable, substantially non-abradable, substantially non-abrasive elastomeric material.

5. The writing implement of claim 1, wherein the page-turning element has a textured exterior surface.

6. The writing implement of claim 5, wherein the textured exterior surface includes a multiplicity of soft, deformable protuberances.

7. The writing implement of claim 1, wherein the writing tip is extendable from and retractable into the first end of the barrel by means including an actuation button on the exterior of the main portion of the barrel.

8. The writing implement of claim 1, wherein the writing tip is extendable from and retractable into the first end of the barrel by means including an actuation button extending from the second end of the barrel, the button being covered by and actuatable through the page-turning implement.

9. A writing implement, comprising:
a barrel having a first end, a second end, and a main portion extending therebetween, the barrel having a first maximum diameter;
a writing tip extending from the first end; and
a page-turning element made of a soft, deformable, substantially non-abradable, substantially non-abrasive elastomeric material permanently fixed to the second end, the page-turning element substantially conforming to the configuration of the second end and having a second maximum diameter that is not more than about 50% greater than the first maximum diameter.

10. The writing implement of claim 9, wherein the second maximum diameter is not more than about 25% greater than the first maximum diameter.

11. The writing implement of claim 9, wherein the page-turning element has a textured exterior surface.

12. The writing implement of claim 11, wherein the textured exterior surface includes a multiplicity of soft, deformable protuberances.

13. The writing implement of claim 9, wherein the writing tip is extendable from and retractable into the first end of the barrel by means including an actuation button on the exterior of the main portion of the barrel.

14. The writing implement of claim 9, wherein the writing tip is extendable from and retractable into the first end of the barrel by means including an actuation button extending from the proximal end of the barrel, the button being covered by and actuatable through the page-turning implement.

15. In a writing implement, of the type having a barrel having a first end, a second end, and a writing tip extending from the first end, wherein the barrel has a first maximum diameter, the improvement comprising:
a page-turning element made of a soft, deformable, substantially non-abradable, substantially non-abrasive elastomeric material permanently fixed to the second end, the page-turning element being configured as a cap covering and substantially conforming to the configuration of the second end and having a second maximum diameter that is not more than about 50% greater than the first maximum diameter, wherein the page-turning element has a textured, friction-enhancing exterior surface.

16. The writing implement of claim 15, wherein the second maximum diameter is not more than about 25% greater than the first maximum diameter.

17. The writing implement of claim 15, wherein the textured exterior surface includes a multiplicity of soft, deformable protuberances.

18. The writing implement of claim 15, wherein the writing tip is extendable from and retractable into the first end of the barrel by means including an actuation button on the exterior of the main portion of the barrel.

19. The writing implement of claim 15, wherein the writing tip is extendable from and retractable into the first end of the barrel by means including an actuation button extending from the proximal end of the barrel, the button being covered by and actuatable through the page turning implement.
